(19) United States
(12) Patent Application Publication
(10) Pub. No.: US 2003/0225636 A1
(43) Pub. Date: Dec. 4, 2003

(54) Network-based just-in-time material shortage and supply information exchange system and method

(76) Inventors: Te-Mei Chu, Taipei (TW); Shu-Mei Chien, Taipei (TW); Yun-Chi Lee, Taipei (TW); Kuan-I Wu, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/292,264

(22) Filed: Nov. 12, 2002

(30) Foreign Application Priority Data
May 29, 2002 (TW) 91111403

(51) Int. Cl. G06F 17/60

(52) U.S. Cl. 705/28

(57) ABSTRACT

A network-based just-in-time (JIT) material shortage and supply information exchange system and method is proposed, which is intended for use in the supply chain management for a supplier and a manufacturer to allow the supplier and the manufacturer to exchange information about the manufacturer's current condition of material shortage and the supplier's capability to supply material for the shortage in a real-time online manner over a network system, such as the Internet. The proposed system and method of the invention is characterized by the use of an Internet-linked server to provide online information about the manufacturer's current condition of material shortage and relevant data to the supplier as well as the information about the supplier's current inventory stock of material and relevant data, such as percentage of reserved amount of supply, to the manufacturer.

### BACKGROUND OF THE INVENTION

1. Field of the Invention

This invention relates to network-based information technology, and more particularly, to a network-based just-in-time (JIT) material shortage and supply information exchange system and method, which is intended for use in the supply chain management for a supplier and a manufacturer to allow the supplier and the manufacturer to exchange information about the manufacturer's current condition of material shortage and the supplier's capability to supply material for the shortage in a real-time online manner over a network system, such as the Internet, so as to allow the supplier to supply material to the manufacturer in a just-in-time (JIT) manner and prepare well in advance to prevent oversupply or undersupply and also allow the manufacturer to carry out purchase management well in advance to prevent shortage of material supply.

2. Description of Related Art

In the manufacture industry, such as the CEM (Contract Electronics Manufacture) industry, the manufacturer is dependent on a supplier for supply of materials such as electronic components, that are used for the assembly of various electronic products, such as computers or the like. To make the manufacture efficient, it is an important task to carry out efficient supply chain management for the transaction between the manufacturer and the supplier and allow both sides to be fully aware of the manufacturer's current condition of material shortage, so as to allow the manufacturer to perform inventory management tasks more efficiently and allow the supplier to supply material in a just-in-time (JIT) manner to let the manufacturer always have sufficient material for manufacture.

Traditionally, the information and relevant data about the current condition of material shortage on the manufacturer side are prepared by the manufacturer on printed documents and sent to the supplier by mail or fax to let the supplier know the manufacturer's current condition of material shortage.

One drawback to the above-mentioned conventional paperwork-based information exchange method, however, is that the use of printed documents for exchanging all the information and relevant data about the manufacturer's current condition of material shortage is quite laborious and time-consuming and would not allow real-time inquiry and update of all the related information, making the supply chain management for the transaction between the manufacturer and the supplier unsatisfactorily inefficient.

### SUMMARY OF THE INVENTION

It is therefore an objective of this invention to provide a network-based JIT material shortage and supply information exchange system and method, which allows a manufacturer and a supplier to exchange information about the manufacturer's current condition of material shortage and the supplier's current inventory stock of material and other relevant data in an online real-time manner.

The network-based JIT material shortage and supply information exchange system and method of the invention allows a supplier and a manufacturer to exchange information about the manufacturer's current condition of material shortage and the supplier's current inventory stock of material and other relevant data, and which is characterized by the use of an Internet-linked server to provide online information about the manufacturer's current condition of material shortage and relevant data to the supplier as well as the information about the supplier's current inventory stock of material and relevant data, such as percentage of reserved amount of supply, to the manufacturer by means of a Material-Shortage Status Inquiry Web page and a Specific Rate Reserved Inventory Stock Web page.

The network-based JIT material shortage and supply information exchange system and method of the invention is more advantageous than prior art in that it allows the manufacturer and the supplier to exchange information about supply chain management efficiently in an online real-time manner, so as to allow the supplier to prepare well in advance to prevent oversupply or undersupply and also allow the manufacturer to carry out purchase management well in advance to prevent shortage of material supply.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the network-based JIT material shortage and supply information exchange system according to the invention;

FIG. 2A shows an example of the screen display of a Material-Shortage Status Inquiry Web page provided by the network-based JIT material shortage and supply information exchange system and method according to the invention;

FIG. 2B shows an example of the screen display of a Specific Rate Reserved Inventory Stock Web page provided by the network-based JIT material shortage and supply information exchange system and method according to the invention;

FIG. 3 is a flow diagram showing the procedural steps performed by the network-based JIT material shortage and supply information exchange system and method according to the invention.

### DETAILED DESCRIPTION OF PREFERRED EMBODIMENTS

The network-based JIT material shortage and supply information exchange system and method according to the invention is disclosed in full details by way of preferred embodiments in the following with reference to the accompanying drawings.

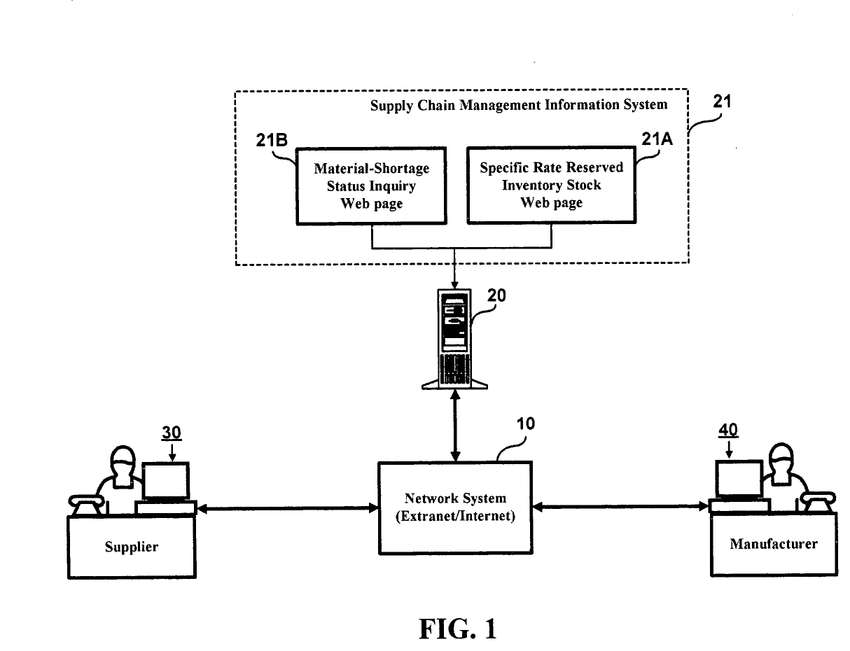

FIG. 1 is a schematic diagram showing the system architecture of the network-based JIT material shortage and supply information exchange system of according to the invention. As shown, the network-based JIT material shortage and supply information exchange system according to the invention comprises: (a) a network system 10; (b) a server 20; (c) at least one first-party workstation 30; and (d) at least one second-party workstation 40, and which is intended for use by a supplier (i.e., the first party) and a manufacturer (i.e., the second party) to exchange information about the manufacturer's current condition of material shortage and the supplier's current inventory stock of material and other relevant data in an online real-time manner over the network system 10.

The network system 10 can be, for example, the Internet or an extranet system dedicatedly established between the supplier and the manufacturer, and which is linked to the server 20, the first-party workstation 30, and the second-party workstation 40 to allow the server 20, the first-party workstation 30, and the second-party workstation 40 to exchange data therethrough.

The server 20 is linked to the network system 10 and installed with a supply chain management information system 21 capable of serving up a Material-Shortage Status Inquiry Web page 21A and a Specific Rate Reserved Inventory Stock Web page 21B. Any authorized workstations (i.e., the first-party workstation 30 and the second-party workstation 40) can gain access to the Material-Shortage Status Inquiry Web page 21A and the Specific Rate Reserved Inventory Stock Web page 21B by linking via the network system 10 to the server 20.

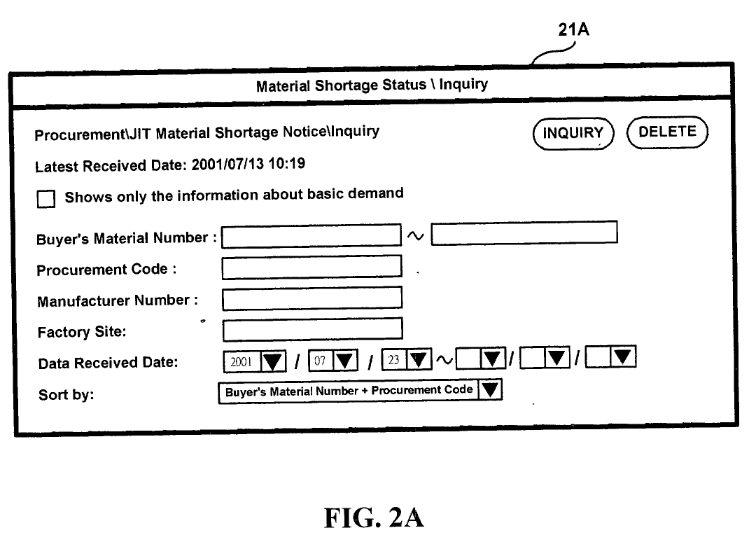

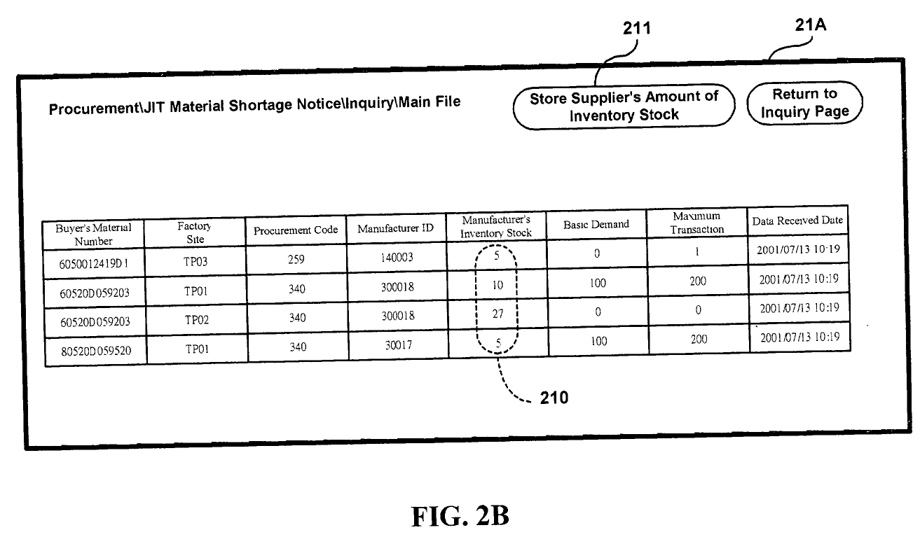

FIG. 2A shows an example of the screen display of the Material-Shortage Status Inquiry Web page 21A, which can be displayed on the computer screen (not shown) of the first-party workstation 30 or the second-party workstation 40 when being linked. This Material-Shortage Status Inquiry Web page 21A allows the supplier to inquire for the condition of material shortage on the manufacturer side.

FIG. 2B shows an example of the screen display of the Specific Rate Reserved Inventory Stock Web page 21B, which can be displayed on the computer screen (not shown) of the first-party workstation 30 or the second-party workstation 40 when being linked. In particular, this Specific Rate Reserved Inventory Stock Web page 21B allows the supplier to learn the manufacturer's current condition of material shortage and relevant data and post the information about the supplier's current inventory stock of material that can be supplied to the manufacturer to make up the material shortage on the manufacturer side. In addition, the Specific Rate Reserved Inventory Stock Web page 21B is used to display the information about the supplier's specific rate reserved inventory stock of material, which is equal to the manufacturer's demand based on a forecast production capacity during a specific further period, such as the next four weeks, multiplied by a specific rate, such as 25%. This allows the supply chain management information system 21 to compute for the percentage of reserved amount of supply based on the manufacturer's current condition of material shortage and the supplier's current inventory stock of material.

The first-party workstation 30 is a computer unit on the supplier side, which can be linked via the Internet 10 to the supply chain management information system 21 on the server 20 by the use of a Web browser program, such as Microsoft Internet Explorer or Netscape Navigator, and use the Web browser program to post data on or browse the contents of the Material-Shortage Status Inquiry Web page 21A and the Specific Rate Reserved Inventory Stock Web page 21B.

The second-party workstation 40 is a computer unit on the manufacturer's side, which can be linked via the Internet 10 to the supply chain management information system 21 on the server 20 by the use of a Web browser program, such as Microsoft Internet Explorer or Netscape Navigator, and use the Web browser program to post data on or browse the contents of the Material-Shortage Status Inquiry Web page 21A and the Specific Rate Reserved Inventory Stock Web page 21B. In one preferred embodiment of the invention, for example, the second-party workstation 40 is an integrated part of an ERP (Enterprise Resource Planning) system installed at the manufacturer's site, which allows the manufacturer to transfer information about the manufacturer's current condition of material shortage and relevant data to the supply chain management information system 21 on the server 20, so as to allow the supplier to gain access to such information online via the Internet 10.

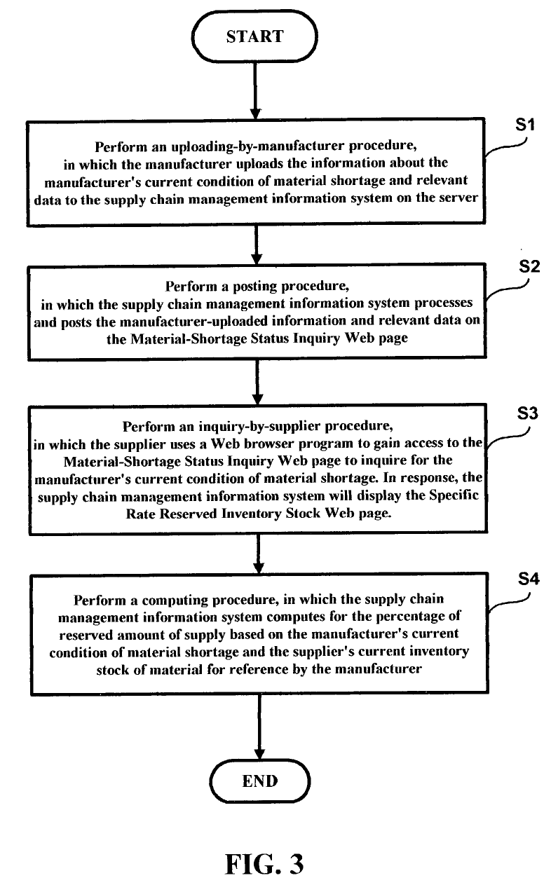

FIG. 3 is a flow diagram showing the procedural steps performed by the network-based JIT material shortage and supply information exchange system and method according to the invention.

As shown, in the first step S1, an uploading-by-manufacturer procedure is performed, in which the manufacturer utilizes the second-party workstation 40 in its internal ERP system to link via the network system 10 to the supply chain management information system 21 on the server 20, and then upload the information about the manufacturer's current condition of material shortage and relevant data to the supply chain management information system 21.

In the next step S2, a posting procedure is performed, in which the supply chain management information system 21 process and post the manufacturer-uploaded information and relevant data on the Material-Shortage Status Inquiry Web page 21A.

In the next step S3, an inquiry-by-supplier procedure is performed, in which the supplier links its first-party workstation 30 via the Internet 10 to the supply chain management information system 21 on the server 20, and use a Web browser program, such as Microsoft Internet Explorer or Netscape Navigator, to gain access to the Material-Shortage Status Inquiry Web page 21A and use it to inquire for a particular manufacturer's current condition of material shortage. In response, the supply chain management information system 21 will display the Specific Rate Reserved Inventory Stock Web page 21B.

In the next step S4, when there is a change in the supplier's current inventory stock of material, a computing procedure is performed, in which the supplier uses the data input box 210 in the Specific Rate Reserved Inventory Stock Web page 21B to input the relevant data about the change in the inventory stock of material and then click the button [Store Supplier's Amount of Inventory Stock] 211. This causes the supply chain management information system 21 to compute for the percentage of reserved amount of supply based on the manufacturer's current condition of material shortage and the supplier's current inventory stock of material. This allows the manufacturer to browse the information about the supplier's current inventory stock of material by using a Web browser program on the second-party workstation 40 linked via the Internet 10 to the Specific Rate Reserved Inventory Stock Web page 21B.

In conclusion, the invention provides a network-based JIT material shortage and supply information exchange system and method, which allows a supplier and a manufacturer to exchange information about the manufacturer's current condition of material shortage and the supplier's current inventory stock of material and other relevant data, and which is characterized by the use of an Internet-linked server to provide online information about the manufacturer's current condition of material shortage and relevant data to the supplier as well as the information about the supplier's current inventory stock of material and relevant data, such as percentage of reserved amount of supply, to the manufacturer by means of a Material-Shortage Status Inquiry Web page and a Specific Rate Reserved Inventory Stock Web page. This feature allows the manufacturer and the supplier to exchange the information about their supply chain management more efficiently in an online real-time manner, so as to allow the supplier to prepare well in advance to prevent oversupply or undersupply and also allow the manufacturer to carry out purchase management well in advance to prevent shortage of material supply.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is

1. A network-based JIT material shortage and supply information exchange method for use to allow a manufacturer and a supplier to exchange information about the manufacturer's current condition of material shortage and relevant data in an online manner via a server linked via a network system to a first-party workstation on the supplier side and a second-party workstation on the manufacturer side;
the network-based JIT material shortage and supply information exchange method comprising:
performing an uploading-by-manufacturer procedure, wherein the manufacturer utilizes the second-party workstation to upload the information about the manufacturer's current condition of material shortage and relevant data via the network system to the server;
serving up a Material-Shortage Status Inquiry Web page to the supplier's first-party workstation for the supplier to inquire for the information about the manufacturer's current condition of material shortage and relevant data;
serving up a Specific Rate Reserved Inventory Stock Web page to the supplier's first-party workstation to allow the supplier to input the information about the supplier's current inventory stock of material and relevant data; and
computing for the percentage of reserved amount of supply based on the manufacturer's current condition of material shortage and the supplier's current inventory stock of material for reference by the manufacturer.

2. The network-based JIT material shortage and supply information exchange method of claim 1, wherein the network system is selected from the types comprising Internet and extranet system.

3. The network-based JIT material shortage and supply information exchange method of claim 1, wherein the first-party workstation and the second-party workstation each utilizes a Web browser program to link to the productivity-forecast inquiry Web page and the productivity-forecast responding Web page.

4. The network-based JIT material shortage and supply information exchange method of claim 3, wherein the Web browser program is Microsoft Internet Explorer.

5. The network-based JIT material shortage and supply information exchange method of claim 3, wherein the Web browser program is Netscape Navigator.

6. A network-based JIT material shortage and supply information exchange system for use to allow a manufacturer and a supplier to exchange information about the manufacturer's current condition of material shortage and relevant data in an online manner via a server linked via a network system to a first-party workstation on the supplier side and a second-party workstation on the manufacturer side;
the network-based JIT material shortage and supply information exchange system comprising:
a network system;
a server, which is linked to the network system, and which is installed with a supply chain management information system which can serve up at least one Material-Shortage Status Inquiry Web page and one Specific Rate Reserved Inventory Stock Web page;
at least one first-party workstation, which is installed on the supplier side, and which is linkable via the network system to the inventory management system on the server; and
at least one second-party workstation, which is installed on the manufacturer side, and which is linkable via the network system to the inventory management system on the server;
wherein
the manufacturer can link the second-party workstation via the network system to the supply chain management information system on the server and upload the information about the manufacturer's current condition of material shortage and relevant data via the network system to the supply chain management information system on the server;
and wherein
the supplier can link the first-party workstation via the network system to the supply chain management information system on the server to browse the Material-Shortage Status Inquiry Web page and thereby browse the information about the manufacturer's current condition of material shortage and relevant data;
and when there is a change in the supplier's current inventory stock of material, the supplier can use the Specific Rate Reserved Inventory Stock Web page to input relevant data to cause the supply chain management information system to compute for the percentage of reserved amount of supply based on the manufacturer's current condition of material shortage and the supplier's current inventory stock of material for reference by the manufacturer.

7. The network-based JIT material shortage and supply information exchange system of claim 6, wherein the network system is selected from the types comprising Internet and extranet system.

8. The network-based JIT material shortage and supply information exchange system of claim 6, wherein the first-party workstation and the second-party workstation each utilizes a Web browser program to link to the productivity-forecast inquiry Web page and the productivity-forecast responding Web page in the purchase management system.

9. The network-based JIT material shortage and supply information exchange system of claim 8, wherein the Web browser program is Microsoft Internet Explorer.

10. The network-based JIT material shortage and supply information exchange system of claim 8, wherein the Web browser program is Netscape Navigator.
